(19) United States
(12) Patent Application Publication
(10) Pub. No.: US 2023/0302534 A1
(43) Pub. Date: Sep. 28, 2023

(54) GRANULATED POWDER FOR MAKING GREEN BODY WITH HIGH STRENGTH

(71) Applicant: United Powder Technologies Company Limited, Taoyuan (TW)

(72) Inventor: Yang-Liang FAN, Taoyuan (TW)

(21) Appl. No.: 18/188,878

(22) Filed: Mar. 23, 2023

(30) Foreign Application Priority Data
Mar. 25, 2022 (TW) 111111480

(51) Int. Cl. B22F 1/103; B22F 1/107; B22F 1/052; B22F 3/16; H01F 1/26

(52) U.S. Cl. CPC B22F 1/103; B22F 1/107; B22F 1/052; B22F 3/16; H01F 1/26; B22F 2304/056; B22F 2304/058; B22F 2304/10; B22F 2998/10

(57) ABSTRACT

Disclosed herein is a granulated powder comprising a metal, a crosslinking agent and a water-soluble thermoplastic binder. The thermoplastic binder accounts for 5.0 to 18 percent by volume of a total volume, the crosslinking agent accounts for 1.0 to 8.0 percent by volume of the total volume, and the metal accounts for a remainder. The thermoplastic binder is a water-soluble polyvinyl alcohol, a polyvinyl butyral, a polyvinyl pyrrolidone, a polyethylene glycol, a hydrolyzed polymaleic anhydride or any combination of the foregoing, the crosslinking agent is an epoxy resin, a polyester resin, a polyester polyol or any combination of the foregoing.

### FIELD OF THE INVENTION

The present disclosure relates to a granulated powder for preparing a green body with a high green strength, and particularly relates to a granulated powder containing thermoplastic binder and crosslinking agents.

### BACKGROUND OF THE INVENTION

The flowability of fine powder is poor and thus cannot be used in the industry, particularly in automated production lines where powders must flow easily into the mold. However, after fine powders are granulated, the flowability of the powder can be improved, so green bodies of various shapes may be formed by a forming machine. According to the required applications, thermoplastic and thermosetting binders may be used in the granulation process. For example, the thermoplastic binders such as polyvinyl alcohol (PVA) or polyvinyl butyral (PVB) resin are used for granulating fine metal powders. The granulated powder can then be pressed into green bodies to make sintered structural parts. Alternatively, this granulation process may be applicable for making molded inductors, where the thermosetting binders such as epoxy resin or phenolic resin will be used due to the need for heat resistance.

Related technologies can be found in U.S. Pat. Pub. No.2021/0221745A1, U.S. Pat. Nos. 10,0384,941B2, 10,716,649B2, 10,526,492B2 and so on.

Such thermoplastic resins such as water-soluble PVA, due to good film-forming property, can be uniformly coated on surface of raw fine powder during granulation and serve as a binder to bond raw fine powders, so that the granulated powder has the advantages of high degree of sphericity, excellent flowability and improved compressibility (high density of green bodies). However, the strength of the green body prepared with these powders is low and thus defects often occur during parts handling and during machining such as drilling, milling, and tapping. In contrast, the green strength and the heat resistance can be greatly improved by heating with a granulated powder obtained by using the thermosetting resins. For example, after the thermosetting resins are thermally cured, the green strength of the green bodies can reach 20 MPa or more and the heat resistance for electric components can reach 160° C. or higher. However, most thermosetting resins are poor in film-forming property and are not water-soluble, so that a large amount of organic solvent is required to dissolve the thermosetting resin for preparing the input material for the granulation process. In addition, the granulated powder needs to be preserved at low temperature to avoid swelling of the green body caused by room temperature curing.

Furthermore, the match between the thermoplastic binder, crosslinking agent, plasticizer, and solvent (water or organics) is difficult. For example, PVA and PEG (polyethylene glycol) are soluble in water but most thermosetting resins are not; when organic solvent, such as acetone, is used to dissolve thermosetting resins, it cannot dissolve PVA. Moreover, when organic solvent is used for granulation such as spray drying, the cost in processing and the investment for closed-loop explosion-proof equipment increase significantly. In addition, organic solvents are not environmentally friendly compared to water. Due to these disadvantages, a remedy is required to overcome these problems and a new granulated powder is needed.

### SUMMARY OF THE INVENTION

This summary is not intended to identify critical or essential features of the disclosure provided herein, but instead merely summarizes certain features and variations thereof.

In one aspect, the present disclosure relates to a granulated powder for making a green body with high strength after being cured, the granulated powder comprises: a metal; a water-soluble thermoplastic binder; and a crosslinking agent. The thermoplastic binder accounts for 5.0 to 18 percent by volume of a total volume, the crosslinking agent accounts for 1.0 to 8.0 percent by volume of the total volume, and the metal accounts for a remainder. The thermoplastic binder is a water-soluble polyvinyl alcohol (PVA), a polyvinyl butyral (PVB), a polyvinyl pyrrolidone (PVP), a polyethylene glycol (PEG), a hydrolyzed polymaleic anhydride (PMA) or any combination of the foregoing, the crosslinking agent is an epoxy resin, a polyester resin, a polyester polyol or any combination of the foregoing.

In another aspect, the present disclosure relates to a powder metallurgical product, which is obtained by pressing loose-packed powders of the granulated powder into the green body and followed by debinding and sintering.

In another aspect, the present disclosure relates to a powder metallurgical product, which is obtained by pressing loose-packed powders of the granulated powder into the green body and followed by curing.

Additional advantages will be set forth in part in the description which follows or may be learned by practice. The advantages will be realized and attained by means of the features particularly pointed out in the appended claims.

### DETAILED DESCRIPTION OF THE PREFERRED EMBODIMENTS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Herein, although steps are performed in a particular order in some embodiments, these steps still may be performed in another reasonable order. For different embodiments, some of the features described below may be substituted or eliminated. It will be appreciated that some additional operations may be performed before, during, or after the described method, and in other embodiments of the method, some operations may be replaced or omitted.

The disclosure provides a granulated powder for preparing a green body with a high green strength, high heat resistance and improved electrical properties. The granulated powder comprises a metal, a crosslinking agent and a water-soluble thermoplastic binder.

In terms of the chemical composition of the one or more granulated powders, the thermoplastic binder accounts for 5.0 to 18 percent by volume of a total volume of the one or more granulated powders, the crosslinking agent accounts for 1.0 to 8.0 percent by volume of the total volume, and the metal accounts for a remainder. The thermoplastic binder maybe a water-soluble polyvinyl alcohol (PVA), a polyvinyl butyral (PVB), a polyvinyl pyrrolidone (PVP), a polyethylene glycol (PEG), a hydrolyzed polymaleic anhydride (PMA) or any combination of the foregoing, the crosslinking agent maybe an epoxy resin, a polyester resin, a polyester polyol or any combination of the foregoing. The crosslinking agent may be soluble in water or in organic solvent.

The disclosure further provides a powder metallurgical product, which is made from the granulated powder. The powder metallurgical product may be manufactured by the following steps:
Step 1: pressing the granulated powder to obtain a green body;
Step 2: heating the green body such that the green body can be cured; and
Step 3: debinding and then sintering the green body to obtain the powder metallurgical product.

The disclosure further provides a powder metallurgical product, which is made from the granulated powder. The powder metallurgical product may be manufactured by the following steps:
Step 1: pressing the granulated powder to obtain a green body;
Step 2: heating the green body such that the green body can be cured;
Step 3: machining the green body to a desired shape; and
Step 4: debinding and sintering the green body to obtain the powder metallurgical product.

Due to the high strength of the cured green body made from the granulated powder, a machining process is capable of performing on the cured green body, which is much easier than the sintered product thus the cost is much lower.

The disclosure further provides a powder metallurgical product, which is made from the granulated powder. The powder metallurgical product is an electronic component with a high heat resistance in electrical properties. In an example, the electronic component is an inductor. The powder metallurgical product may be manufactured by the following steps:
Step 1: pressing the granulated powder to obtain a green body; and
Step 2: heating the green body such that the green body is cured.

Due to the crosslinking reaction between the thermoplastic and the crosslinking agent, the heat resistance of electrical properties of the cured body is greatly improved.

The granulated powder is prepared by using a granulation process. The granulation process described herein may be a spray-drying granulation process, a rolling granulation process or a mechanical stirring granulation process. The granulation process may be implemented by using a spray-drying granulator, a rolling granulator or a mechanical stirring granulator. In the following context, the spray-drying granulation process is used as an example, but the present disclosure is not limited thereto.

In an embodiment, the granulated powder is made directly from a granulation process and a resultant product obtained may be described as a co-spray-dried granulated powder. The preparation of the co-spray-dried granulated powder is described below. The thermoplastic binder and the crosslinking agent are mixed with a fine metal powder and water to form a slurry in a stirring manner at a high speed. Then, the slurry is subjected to the granulation process to obtain the granulated powder.

The crosslinking agent may be a single-component epoxy resin or an epoxy-containing compound, a low-molecular-weight polyester resin, a carboxyl-containing compound, a glyoxal-or aldehyde-containing compound or any combination of the foregoing. In addition, the crosslinking agent may be water-soluble. For example, the crosslinking agent may be an aqueous crosslinking agent, such as an aqueous epoxy resin or an aqueous polyester resin. In this embodiment, mixing and granulation are implemented by using a spray-drying granulator.

In an embodiment, in terms of the composition of the one or more granulated powders, the thermoplastic binder may be PVA or a combination of PVA and PEG, which accounts for 5.5 percent to 6.5 percent by volume of the total volume, the crosslinking agent may be polyester polyol, which accounts for 2.0 percent to 3.0 percent by volume of the total volume, and the fine metal powder (or the metal) may be Fe-3.5Si-4.5Cr, which accounts for the remainder.

In another embodiment, a first granulated powder without the presence of the crosslinking agent is produced and then the crosslinking agent is added into the first granulated powder to obtain the granulated powder. A resultant product obtained may be described as a mixed-type granulated powder.

The preparation of the mixed-type granulated powder is described below. The fine metal powder, the thermoplastic binder and water are mixed to obtain a mixture firstly, and then the mixture is subjected to the granulation process to obtain the first granulated powder. Next, the crosslinking agent is added to and mixed with the first granulated powder to produce the granulated powder. A method of mixing the crosslinking agent with the first granulated powder may appropriately be selected from the hitherto known mixing methods, and it is not particularly limited, but examples thereof may include methods using a stirrer in a dry or wet mixing manner. In this embodiment, the crosslinking agent is a powdered crosslinking agent, such as a powdered epoxy resin.

In this embodiment, in terms of the composition of the raw materials, the thermoplastic binder accounts for 1.0 percent to 6.0 percent by volume of a total volume of the mixture including the thermoplastic binder, the water and the fine metal powder, the water accounts for 45 percent to 83 percent by volume of the total volume of the mixture, and the fine metal powder accounts for a remainder of the mixture. After spray drying, the crosslinking agent is added to the first granulated powder in a range of 1.0 percent to 8.0 percent by volume relative to a total volume of the crosslinking agent and the first granulated powder.

In an example, the thermoplastic binder in the first granulated powder may be PVA or a combination of PVA and PEG, which accounts for 3.0 percent to 6.0 percent by volume of the total volume of a mixture including the first granulated powder, the crosslinking agent and an organic solvent. The crosslinking agent may be a combination of an epoxy resin and a polyester resin, which accounts for 0.5 percent to 3.0 percent by volume of the total volume of the mixture. The crosslinking agent is mixed with the first granulated powder in the organic solvent, which accounts for 26 percent to 36 percent by volume of the total volume of the mixture. The organic solvent may be acetone. The crosslinking agent is mixed with the first granulated powder via wet mixing. The fine metal powder may be SKD11 (Japanese Industrial Standards JIS SKD11) or Fe-8Ni.

The following examples are used to demonstrate possible formulations to utilize the present disclosure, and the application of the present disclosure is not restricted by the given examples. It should be noted that modifications or improvements can be made based on the following examples; however, such modifications or improvements while not deviating from the application or effectiveness of the present disclosure are still covered by this patent. In the following examples, the granulated powder is poured into a mold to obtain loose-packed powders, which are then subjected to a press forming step to form a green body. Then, the green body is heated to a temperature in a range between 50° C. and 300° C., such that a crosslinking reaction is taking place between the thermoplastic binder and the crosslinking agent to cure the green body.

Since the thermoplastic binder and the crosslinking agent, either added prior to or after granulation, are introduced into the granulated powder, the thermoplastic binder and the crosslinking agent in the granulated powder will be cross-linked when heating. From a chemical reaction perspective, with the thermoplastic binder which is PVA or PVB as an example, the hydroxyl groups of PVA or PVB can combine with the epoxy resin and polyester resin to form a polymer with a three-dimensional structure, thus increasing the strength and structure stability. So, the hydroxyl groups of PVA or PVB may be regarded as a hardener of the epoxy resin. As a result, a strengthening effect is provided in the granulated powder according to the present disclosure, without using the traditional thermosetting resins and the organic solvent for dissolving the thermosetting resins.

In a traditional powder metallurgy process, the increase of the green strength results from an increase in a mechanical locking force between the powders through press forming to deform the powder. For large-particle-size powders (for example, with a median particle size D50 of greater than or equal to about 75 μm), because the powders are coarse, the powders subjected to press forming are easily deformed, and there is a sufficient mechanical locking force or cold welding effect between the powders, so that the problem of low green strength may be improved or solved. However, for small-particle-size powders (for example, with a median particle size D50 of less than or equal to about 20 μm), because the powders are fine, the number of contact points between the powders is large in view of the entire sample and the friction force is high, the small-particle-size powders are difficult to deform during forming, and a mechanical locking force between the powders is insufficient, so that the green strength is low. Therefore, the present disclosure is particularly applicable to small-particle-size granulated powders. According to an embodiment of the present disclosure, the particle size D50 of the fine metal powder ranges between 0.2 μm and 20 μm.

In the present disclosure, both the thermoplastic resin (such as PVA) and the crosslinking agent (such as an epoxy resin and a polyester resin) are existed simultaneously in the granulated powder. When the green body, which is prepared from the granulated powder, are subjected to curing at a high temperature, a chemical reaction is generated between PVA and the epoxy resin or the polyester resin, so as to obtain a high green strength and high heat resistance.

### EXPERIMENTAL EXAMPLES

### Experimental Examples 1-4

The powder, the water-soluble thermoplastic binder, the water-soluble crosslinking agent and water are mixed firstly, followed by spray-drying granulation to obtain a granulated powder, and the granulated powder is press formed at 600 MPa, followed by heating under different baking conditions. A green size used for green strength measurement is 18 mm×18 mm×2.2 mm, and a T Core size used for magnetic characteristic measurement is 12.85 mm in outer diameter (OD), 7.75 mm in inner dimeter (ID) and 2.00 mm in height (H). The compositions and baking conditions of Experimental example 1, Experimental example 2, Experimental example 3, and Experimental example 4 are listed in Table 1.

### Comparative Examples 1-2

The powder, the thermoplastic binder and water are mixed firstly, followed by spray-drying granulation to obtain a granulated powder, and the granulated powder without crosslinking agent is press formed. A green size used for green strength measurement is 18 mm×18 mm×2.2 mm, and a T Core size used for magnetic characteristic measurement is 12.85 mm in outer diameter (OD), 7.75 mm in inner diameter (ID) and 2.00 mm in height (H). The compositions of Comparative example 1 and Comparative example 2 are shown in Table 1.

A Fe-3.5Si-4.5Cr pre-alloyed inductor powder, which is a phosphate insulated powder is taken as the powder in Experimental example 1, Experimental example 2, and Comparative example 1, and a phosphate insulated carbonyl iron powder is used in Experimental example 3, Experimental example 4, and Comparative example 2. The crosslinking agent used in Experimental example 1, Experimental example 2, Experimental example 3 and Experimental example 4 is a water-soluble polyester polyol, which contains 30wt. % of methanol, 40 wt. % of water and 30 wt. % of polyester polyol.

TABLE 1

| | Composition (unit: percent by volume) | | | | | | |
|---|---|---|---|---|---|---|---|
| | | thermoplastic | | crosslinking | | baking | baking |
| Group | powder | binder | | agent | solvent | temperature | time |
| Experimental | Fe-3.5Si-4.5Cr | PVA | PEG | polyester | water | 150° C. | 2 h |
| example 1 | | | | polyol | | | |
| | 41.30 | 2.34 | 0.26 | 1.20 | 54.90 | | |
| Experimental | Fe-3.5Si-4.5Cr | PVA | PEG | polyester | water | 200° C. | 2 h |
| example 2 | | | | polyol | | | |
| | 41.30 | 2.34 | 0.26 | 1.40 | 54.90 | | |
| Comparative | Fe-3.5Si-4.5Cr | PVA | PEG | N/A | water | N/A | N/A |
| example 1 | 41.80 | 2.43 | 0.27 | | 55.50 | | |

| | | | | | | |
|---|---|---|---|---|---|---|
| Experimental | carbonyl iron | PVA | polyester | water | 150° C. | 2 h |
| example 3 | powder | | polyol | | | |
| | 41.10 | 3.10 | 1.40 | 54.40 | | |
| Experimental | carbonyl iron | PVA | polyester | water | 200° C. | 2 h |
| example 4 | powder | | polyol | | | |
| | 41.10 | 3.10 | 1.40 | 54.40 | | |
| Comparative | carbonyl iron | phenolic resin | N/A | water | 150° C. | 2 h |
| example 2 | powder | | | | | |
| | 41.50 | 3.60 | | 54.90 | | |

### Property Measurement

The above experimental examples are used to make an inductance component. Experimental example 1, Experimental example 2 and Comparative example 1 are further subjected to an insulation and voltage resistance measurement in addition to the green strength measurement. The conditions of the insulation and voltage resistance measurement are 100 volts and 5 seconds, and the green strength measurement is performed according to MPIF Standard 15. Test results are shown in Table 2.

Experimental example 3, Experimental example 4 and Comparative example 2 are subjected to magnetic inductivity and saturation current measurements, where the magnetic inductivity measurement is implemented by analyzing the inductance value of the samples using a precision impedance analyzer under the conditions of a voltage of 0.25 V and a frequency of 100 kHz, and the saturation current measurement is implemented by providing a superimposed current using a magnetic component analyzer with a high current DC bias source under the conditions of a voltage of 0.25 V and a frequency of 100 kHz. Test results are shown in Table 3.

TABLE 2

| | Resistance | Green strength |
|---|---|---|
| Group | (M ohm) | (MPa) |
| Experimental | 5,265 | 13.1 |
| example 1 | | |
| Experimental | 5,515 | 22.3 |
| example 2 | | |
| Comparative | 5,235 | 6.4 |
| example 1 | | |

TABLE 3

| | Magnetic | Saturation current |
|---|---|---|
| Group | inductivity | (A) |
| Experimental | 13.4 | 24 |
| example 3 | | |
| Experimental | 14.4 | 21 |
| example 4 | | |
| Comparative | 11.7 | 21 |
| example 2 | | |

As can be seen from the measurement in Table 2, in the group in which the crosslinking agent and baking are added, the green strength is significantly improved, and the insulation and voltage resistance also reaches the specification of the product (Comparative example 1). On the other hand, it can be seen from Experimental Example 3, Experimental Example 4 and Comparative example 2 in Table 3 that the magnetic inductivity and saturation current of the component obtained by the granulated powder of the present disclosure are improved.

Moreover, Experimental example 4 is further subjected to a heat resistance test, which is implemented by measuring an inductance value of a sample before and after soaking in a soldering machine, where the temperature of the solder bath is 260° C. and the time of soaking is 15 seconds. The inductance value before soaking is 3.414 (μH), and the inductance value after soaking is 3.370 (μH), with a decrease of only 1.13%, which is within 10% of the general industrial standard and is about 20% better than that of the comparative example 2.

### Experimental Examples 5-7

The powder, the thermoplastic binder and water are mixed firstly, followed by spray-drying granulation to obtain the first granulated powder. The crosslinking agent is dissolved in acetone and then added to the granulated powder by wet mixing. After acetone evaporated, the granulated powder is subjected to press forming at 600 MPa, followed by heating under different baking conditions, where the green size is 18 mm×18 mm×2.2 mm The compositions and curing conditions of Experimental example 5, Experimental example 6, and Experimental example 7 are listed in Table 4.

### Comparative Examples 3-4

The powder, the thermoplastic binder and water are mixed firstly, followed by spray-drying granulation to obtain the granulated powder, and the granulated powder is press formed, where the green size is 18 mm×18 mm×2.2 mm The compositions of Comparative example 3 and Comparative example 4 are shown in Table 4.

In Experimental example 5, Comparative example 3 and Comparative example 4, the composition of the powder is SKD11; and in Experimental example 6 and Experimental example 7, the composition of the powder is Fe-8Ni, and the crosslinking agent contains 49 wt. % of an epoxy resin, 49 wt. % of a polyester resin and 2 wt. % of another resin. In Comparative example 3, the crosslinking agent is not dissolved with acetone, but added directly in the form of dry powder; in Experimental example 5, the crosslinking agent is dissolved with acetone firstly, and then sprayed onto a spray-dried granulated powder in a mixer; in Comparative example 4, the crosslinking agent is not added; and in Experimental example 5, Comparative example 3 and Comparative example 4, a step of baking is further added. In Experimental examples 6 and 7, PVA and PEG in different proportions are used, and in Experimental examples 6 and 7, the crosslinking agent and the step of baking are further added.

TABLE 4

| | Composition (unit: percent by volume) | | | | | baking | baking |
|---|---|---|---|---|---|---|---|
| | | thermoplastic | | crosslinking | | temperature | time |
| Group | powder | binder | | agent | solvent | — | — |
| Comparative | SKD11 | PVA | | Mixture | N/A | 200° C. | 2 h |
| example 3 | | | | of an | | | |
| | | | | epoxy resin | | | |
| | | | | and a | | | |
| | | | | polyester | | | |
| | | | | resin | | | |
| | 92.4 | 6.0 | | 1.6 | N/A | | |
| Experimental | SKD11 | PVA | | Mixture | acetone | 200° C. | 2 h |
| example 5 | | | | of an | | | |
| | | | | epoxy resin | | | |
| | | | | and a | | | |
| | | | | polyester | | | |
| | | | | resin | | | |
| | 63.6 | 4.1 | | 1.1 | 31.2 | | |
| Comparative | SKD11 | PVA | | N/A | N/A | 200° C. | 2 h |
| example 4 | 93.9 | 6.1 | | N/A | N/A | | |
| Experimental | Fe-8Ni | PVA | PEG | Mixture | acetone | 200° C. | 2 h |
| example 6 | | | | of an | | | |
| | | | | epoxy resin | | | |
| | | | | and a | | | |
| | | | | polyester | | | |
| | | | | resin | | | |
| | 63.6 | 3.9 | 0.2 | 1.1 | 31.2 | | |
| Experimental | Fe-8Ni | PVA | PEG | Mixture | acetone | 200° C. | 2 h |
| example 7 | | | | of an | | | |
| | | | | epoxy resin | | | |
| | | | | and a | | | |
| | | | | polyester | | | |
| | | | | resin | | | |
| | 63.6 | 2.9 | 1.2 | 1.1 | 31.2 | | |

### Property Measurement

The experimental examples above are subjected to a green strength measurement, and the green strength measurement is implemented according to a MPIF Standard 15. Test results are shown in Table 5. It can be seen from the measurement of Experimental examples 5, 6, and 7 in Table 5 that the increase of the green strength is the most significant after acetone is used as the solvent to dissolve the crosslinking agent; and it can be seen from the results of Experimental examples 6 and 7 that the higher the PVA content is, the more the increase of the resulting green strength is.

TABLE 5

| Group | Green strength (MPa) |
|---|---|
| Comparative | 11.8 |
| example 3 | |
| Experimental | 26.1 |
| example 5 | |
| Comparative | 8.8 |
| example 4 | |
| Experimental | 32.2 |
| example 6 | |
| Experimental | 18.9 |
| example 7 | |

What is claimed is:

1. A granulated powder for making a green body with high strength after being cured, the granulated powder comprising:
a metal;
a water-soluble thermoplastic binder; and
a crosslinking agent;
wherein the water-soluble thermoplastic binder accounts for 5.0 to 18 percent by volume of a total volume, the crosslinking agent accounts for 1.0 to 8.0 percent by volume of the total volume, and the metal accounts for a remainder; and
wherein the water-soluble thermoplastic binder is a water-soluble polyvinyl alcohol (PVA), a polyvinyl butyral (PVB), a polyvinyl pyrrolidone (PVP), a polyethylene glycol (PEG), a hydrolyzed polymaleic anhydride (PMA) or any combination of the foregoing, the crosslinking agent is an epoxy resin, a polyester resin, a polyester polyol or any combination of the foregoing.

2. The granulated powder according to claim 1, wherein the granulated powder is prepared through spray-drying a mixture of a fine metal powder, the water-soluble thermoplastic binder and the crosslinking agent.

3. The granulated powder according to claim 2, wherein the median particle size of the fine metal powder ranges between 0.2 μm and 20 μm.

4. The granulated powder according to claim 1, wherein the granulated powder is prepared by adding the crosslinking agent into a first granulated powder that is obtained from spray-drying a mixture of a fine metal powder and the water-soluble thermoplastic binder.

5. The granulated powder according to claim 4, wherein the median particle size of the fine metal powder ranges between 0.2 μm and 20 μm.

6. The granulated powder according to claim 4, wherein the crosslinking agent is in a fine powder form to be mixed with the first granulated powder.

7. The granulated powder according to claim 4, wherein the crosslinking agent is dissolved in an organic solvent to be mixed with the first granulated powder.

8. A powder metallurgical product, which is obtained by pressing loose-packed powders of the granulated powder according to claim 1 into the green body and followed by debinding and sintering.

9. A powder metallurgical product, which is obtained by pressing loose-packed powders of the granulated powder according to claim 1 into the green body and followed by curing.

10. The powdered metallurgical product according to claim 9, wherein the powdered metallurgical product is an inductor.
